(19) United States
(12) Patent Application Publication
(10) Pub. No.: US 2018/0272936 A1
(43) Pub. Date: Sep. 27, 2018

(54) DETECTION AND PRESENTATION OF OBSTRUCTED VEHICLE VIEWS

(71) Applicant: Ford Global Technologies, LLC, Dearborn, MI (US)

(72) Inventors: Reid William Kaufman Worthen, Dearborn, MI (US); Victoria Leigh Schein, Dearborn, MI (US)

(21) Appl. No.: 15/469,239

(22) Filed: Mar. 24, 2017

(51) Int. Cl. B60R 1/00; B60R 1/12; H04N 5/247; H04N 5/232; H04N 5/445; G01V 8/12

(52) U.S. Cl. CPC B60R 1/00; B60R 1/12; H04N 5/247; H04N 5/23293; B60R 2300/8026; G01V 8/12; B60R 2001/1253; B60R 2300/105; B60R 2300/205; H04N 5/44591

(57) ABSTRACT

Method and apparatus are disclosed for detection and presentation of obstructed vehicle views. An example vehicle includes a first side mirror, a first camera adjacent to the first side mirror, a first sensor module to detect opaque material on the first side mirror, an obstruction identifier to determine whether viewing of a first area via the first side mirror is obstructed, and a display to present, via the camera, the first area responsive to the obstruction identifier determining viewing via the first side mirror is obstructed.

### CROSS-REFERENCE TO RELATED APPLICATIONS

This application is related to U.S. Application Docket No. 83791863 (NGE File No. 026780.8669), filed on Mar. 24, 2017 and U.S. Application ______, Docket No. 83791849 (NGE File No. 026780.8670), filed on Mar. 24, 2017, which are incorporated herein by reference in their entireties.

### TECHNICAL FIELD

The present disclosure generally relates to vehicle views and, more specifically, to detection and presentation of obstructed vehicle views.

### BACKGROUND

Generally, a vehicle includes a windshield, a rear window, and side windows that partially define a cabin of the vehicle and enable a driver and/or other occupant(s) (e.g., passengers) to view an area surrounding the vehicle. Oftentimes, the windshield is formed from laminated safety glass, and the side and rear windows are formed from tempered glass, laminated glass, polycarbonate, acrylic resins, and/or other materials.

A vehicle also typically includes mirrors (e.g., a rearview mirror, side mirrors) to facilitate a driver in viewing a surrounding area next to and/or behind the vehicle. Oftentimes, the mirrors of the vehicle include a reflective layer (e.g., formed of metallic material) and a glass or plastic layer coupled to the reflective layer to protect the reflective layer from becoming damaged.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for detection and presentation of obstructed vehicle views. An example disclosed vehicle includes a first side mirror, a first camera adjacent to the first side mirror, a first sensor module to detect opaque material on the first side mirror, an obstruction identifier to determine whether viewing of a first area via the first side mirror is obstructed, and a display to present, via the camera, the first area responsive to the obstruction identifier determining viewing via the first side mirror is obstructed.

An example disclosed method for detection and presentation of obstructed vehicle views includes detecting, via a first sensor module, opaque material on a first side mirror and determining, via a processor, whether viewing of a first area via the first side mirror is obstructed. The example disclosed method also includes capturing the first area via a camera and presenting the first area via a display responsive to determining that viewing of the first area is obstructed.

An example disclosed vehicle includes a rearview mirror, a camera adjacent to a rearview window, a sensor module to detect opaque material on the rearview mirror, an obstruction identifier to determine whether viewing of the an area via the rearview mirror is obstructed, and a display to present, via the camera, the area responsive to the obstruction identifier determining that viewing via the rearview mirror is obstructed.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle that detects and presents obstructed views in accordance with the teachings disclosed herein.

FIG. 2 depicts a first screen presented via a display of the vehicle of FIG. 1.

FIG. 3 depicts a second screen presented via a display of the vehicle of FIG. 1.

FIG. 4 illustrates an example sensor module for a rearview window of the vehicle of FIG. 1.

FIG. 5 illustrates another example sensor module for a rearview window of the vehicle of FIG. 1.

FIG. 6 depicts a partial cross-sectional view of the rearview window of FIG. 5.

FIG. 7 is a block diagram of electronic components of the vehicle of FIG. 1.

FIG. 8 is a flowchart for detecting and presenting obstructed views of the vehicle of FIG. 1 in accordance with the teachings disclosed herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Generally, a vehicle includes a windshield, a rear window, and side windows that partially define a cabin of the vehicle and enable a driver and/or other occupant(s) (e.g., passengers) to view an area surrounding the vehicle. Oftentimes, the windshield is formed from laminated safety glass, and the side and rear windows are formed from tempered glass, laminated glass, polycarbonate, acrylic resins, and/or other materials.

Further, a vehicle typically includes a rearview mirror and side mirrors (i.e., side-view mirrors, wing mirrors, fender mirrors) to facilitate a driver in viewing a surrounding area next to and/or behind the vehicle. Oftentimes, rearview mirrors and side mirrors include a reflective layer (e.g., formed of aluminum and/or other metallic material(s)) and a glass or plastic layer coupled to the reflective layer to protect the reflective layer from becoming damaged.

In some instances, opaque material collects on a mirror and/or a corresponding window, thereby potentially preventing a driver from viewing surrounding areas of the vehicle. For example, when a glass temperature is at or below a dew point temperature, a film of condensation and/or ice may form on a window and/or a mirror as a result of condensation collecting on a surface of the window and/or mirror. In some instances, condensation collects on a mirror when a temperature of a glass layer of the mirror is at or below a dew point temperature of air adjacent to the glass layer. In other examples, the opaque material is rain droplets and/or snow that collects on a surface of a window and/or a mirror. Further, in some examples, cracks may form in a glass layer of a window and/or a mirror, thereby potentially resulting in an opaque surface.

Example apparatus and methods disclosed herein include sensor modules that detect when opaque material located on a mirror and/or an adjacent window of the vehicle prevents a driver of the vehicle from viewing a surrounding area via the mirror. The examples apparatus and methods disclosed herein further include a display of the vehicle that presents image(s) and/or video of the obstructed view of the surrounding area that is captured via a camera of the vehicle. For example, the video presents image(s) and/or video of an area next to and/or behind the vehicle when opaque material on a side mirror (i.e., a side-view mirror, a wing mirror, a fender mirror) and/or an adjacent side window prevents the driver from viewing that area via the side mirror. Additionally or alternatively, the video presents image(s) and/or video of an area behind the vehicle when opaque material on a rearview mirror and/or an rearview window prevents the driver from viewing that area via the rearview mirror.

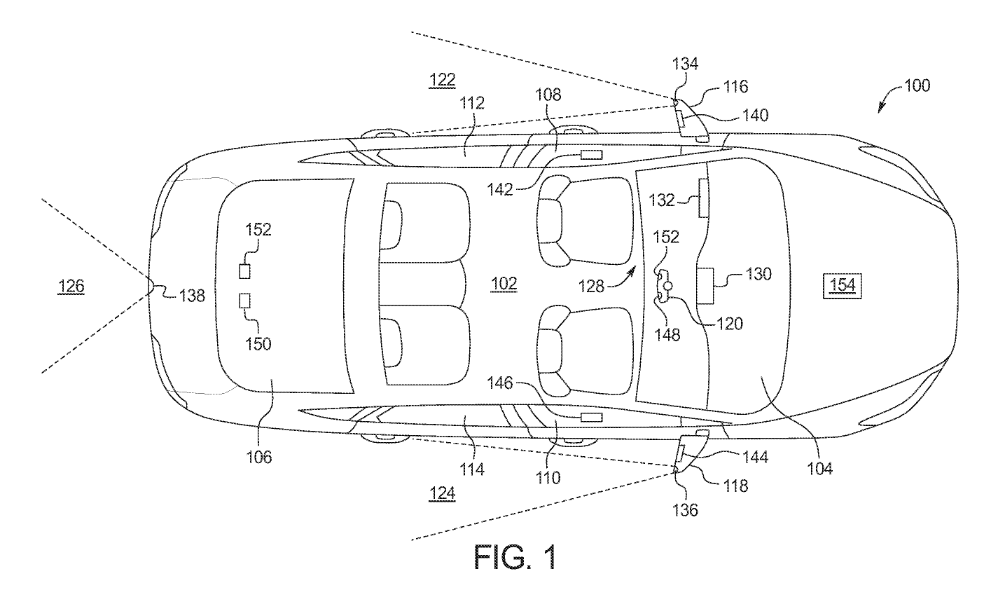

Turning to the figures, FIG. 1 illustrates an example vehicle 100 in accordance with the teachings disclosed herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

In the illustrated example, the vehicle 100 includes a cabin 102, a windshield 104, a rearview window 106, a side window 108 (e.g., a first window, a front driver-side window), a side window 110 (e.g., a second window, a front passenger-side window), a side window 112 (e.g., a third window, a back driver-side window), and a side window 114 (e.g., a fourth window, a back passenger-side window). For example, the windshield 104 is formed from laminated safety glass. The rearview window 106, the side window 108, the side window 110, the side window 112, and the side window 114 are formed from tempered glass, laminated glass, polycarbonate, acrylic resins, and/or other transparent material(s).

Additionally, the vehicle 100 includes a side mirror 116 (e.g., a first side mirror, a driver-side side mirror) adjacent to the side window 108, a side mirror 118 (e.g., a second side mirror, a passenger-side side mirror) adjacent to the side window 110, and a rearview mirror 120. For example, the side mirror 116 enables a driver of the vehicle 100 to view an area 122 (e.g., a first area) adjacent to and/or behind a driver-side of the vehicle 100. The side mirror 118 enables the driver to view an area 124 (e.g., a second area) adjacent to and/or behind a passenger-side of the vehicle 100. Further, the rearview mirror 120 enables the driver to view an area 126 (e.g., a third area) behind the vehicle 100 through the rearview window 106.

The vehicle 100 of the illustrated example also includes an infotainment head unit 128 that provides an interface between the vehicle 100 and a user (e.g., the driver). The infotainment head unit 128 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a display 130 (e.g., a heads-up display, a center console display such as a liquid crystal display (LCD), an organic light emitting diode (OLED) display, a flat panel display, a solid state display, etc.), and/or a speaker 132. In the illustrated example, the infotainment head unit 128 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). For example, the infotainment head unit 128 displays the infotainment system via the display 130.

Further, the vehicle 100 of the illustrated example includes a camera 134 (e.g., a first camera) adjacent to the side mirror 116, a camera 136 (e.g., a second camera) adjacent to the side mirror 118, and a camera 138 (e.g., a third camera) adjacent to the rearview window 106. The camera 134 captures image(s) and/or video of the area 122 adjacent to the vehicle 100. For example, the camera 134 is coupled to the side mirror 116 or another surface of the vehicle 100 adjacent to the side mirror 116 to enable the camera 134 to capture the image(s) and/or video of the area 122. Further, the camera 136 captures image(s) and/or video of the area 124 adjacent to the vehicle 100. For example, the camera 136 is coupled to the side mirror 118 or another surface of the vehicle 100 adjacent to the side mirror 118 to enable the camera 136 to capture the image(s) and/or video of the area 124. Additionally, the camera 138 captures image(s) and/or video of the area 126 behind the vehicle 100. For example, the camera 138 is coupled to the vehicle 100 adjacent to the rearview window 106 to enable the camera 138 to capture the image(s) and/or video of the area 126.

In the illustrated example, the vehicle 100 also includes sensor modules that detect whether opaque material (e.g., condensation, rain droplets, ice, snow, cracked surfaces, etc.) is located on and/or within a transparent or reflective surface of the vehicle 100 (e.g., the windshield 104, the rearview window 106, the side window 108, the side window 110, the side window 112, the side window 114, the side mirror 116, the side mirror 118, the rearview mirror 120). The sensors modules of the vehicle 100 include hardware (e.g., a sensor, a transmitter, a processor, memory, storage, etc.) to detect opaque material on a vehicle surface. Further, the sensor modules may include software to detect opaque material on a vehicle surface. For example, one or more of the sensors modules detect whether opaque material is on a vehicle surface by comparing light intensity measurement(s) collected by sensor(s) adjacent to a first side of a vehicle surface to light intensity measurement(s) collected by other sensor(s) adjacent to an opposing second side of the vehicle surface. Additionally or alternatively, one or more of the sensors modules detect whether opaque material is on a vehicle surface by comparing a reference light intensity to light intensity measurement(s) collected by sensor(s) adjacent to a first side of a vehicle surface for a light beam that is emitted by light transmitter adjacent to an opposing second side of the vehicle surface. Example sensor modules are disclosed as opaqueness detection assemblies in U.S. Application ______, Docket No. 83791863 (NGE File No. 026780.8669), filed on Mar. 24, 2017 and U.S. Application ______, Docket No. 83791849 (NGE File No. 026780.8670), filed on Mar. 24, 2017, which are incorporated herein by reference in their entireties.

As illustrated in FIG. 1, the vehicle 100 includes a sensor module 140 (e.g., a first sensor module), a sensor module 142 (e.g., a second sensor module), a sensor module 144 (e.g., a third sensor module), a sensor module 146 (e.g., a fourth sensor module), a sensor module 148 (e.g., a fifth sensor module), and a sensor module 150 (e.g., a sixth sensor module). The sensor module 140 detects whether opaque material is on (e.g., condensation, rain droplets, snow, ice, etc.) and/or within (e.g., a cracked surface of) the side mirror 116. For example, the sensor module 140 is coupled to and/or positioned near the side mirror 116 to enable the sensor module 140 to monitor the side mirror 116. The sensor module 142 detects whether opaque material is on and/or within the side window 108. For example, the sensor module 142 is coupled to and/or positioned near the side window 108 to enable the sensor module 142 to monitor the side window 108. The sensor module 144 detects whether opaque material is on and/or within the side mirror 118. For example, the sensor module 144 is coupled to and/or positioned near the side mirror 118 to enable the sensor module 144 to monitor the side mirror 118. The sensor module 146 detects whether opaque material is on and/or within the side window 110. For example, the sensor module 146 is coupled to and/or positioned near the side window 110 to enable the sensor module 146 to monitor the side window 110. The sensor module 148 detects whether opaque material is on and/or within the rearview mirror 120. For example, the sensor module 148 is coupled to and/or positioned near the rearview mirror 120 to enable the sensor module 148 to monitor the rearview mirror 120. The sensor module 150 detects whether opaque material is on and/or within the rearview window 106. For example, the sensor module 150 is coupled to and/or positioned near the rearview window 106 to enable the sensor module 150 to monitor the rearview window 106.

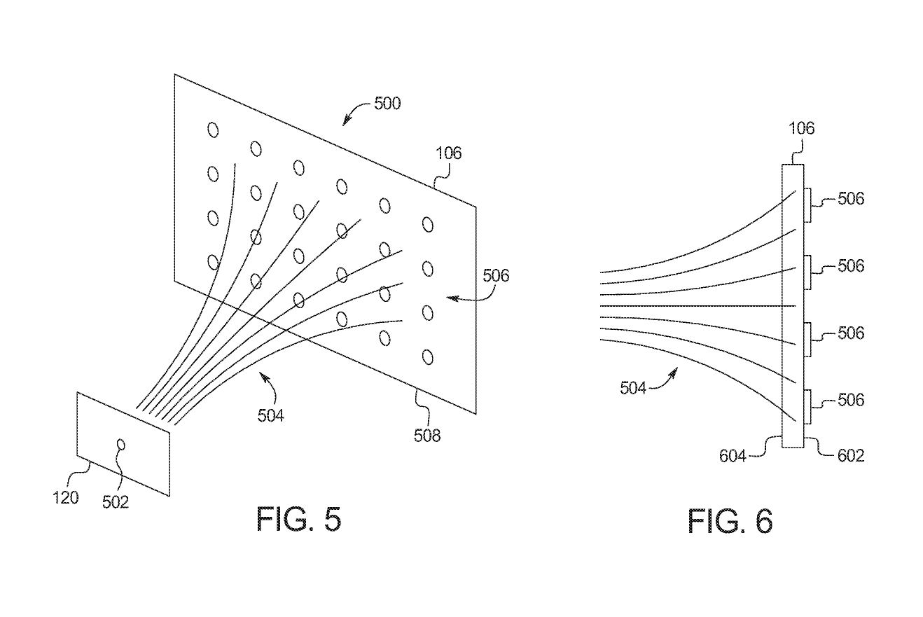

Additionally, the vehicle 100 of the illustrated example includes a sensor module 152 (e.g., a seventh sensor module) that detects whether an object is positioned in the cabin 102 of the vehicle 100 that obstructs the driver from viewing the area 126 via the rearview mirror 120. For example, the sensor module 152 includes transmitter(s) (e.g., light transmitters 402 of FIG. 4, a light transmitter 502 of FIG. 5) coupled to the rearview mirror 120 and/or other surface(s) near the windshield 104 that emit(s) light beam(s) (e.g., light beams 404 of FIG. 4, a light beam 504 of FIG. 5) to sensor(s) (e.g., sensors 406 of FIG. 4, sensors 506 of FIG. 5) coupled to and/or otherwise positioned adjacent to the rearview window 106 to monitor whether there is an obstructing object within the cabin 102.

The vehicle 100 also includes an obstruction identifier 154 that determines whether opaque material and/or object(s) within the cabin 102 are obstructing the driver's view of the area 122 via the side mirror 116, the area 124 via the side mirror 118, and/or the area 126 via the rearview mirror 120.

For example, in response to the sensor module 140 detecting opaque material on the side mirror 116 and/or the sensor module 142 detecting opaque material on the side window 108, the obstruction identifier 154 determines whether viewing of the area 122 by the driver is obstructed by opaque material. In response to the obstruction identifier 154 determining that viewing of the area 122 via the side mirror 116 is obstructed, the camera 134 captures image(s) and/or video of the area 122 and the display 130 presents the image(s) and/or video of the area 122 to the driver.

Additionally or alternatively, in response to the sensor module 144 detecting opaque material on the side mirror 118 and/or the sensor module 146 detecting opaque material on the side window 110, the obstruction identifier 154 determines whether viewing of the area 124 by the driver is obstructed by opaque material. In response to the obstruction identifier 154 determining that viewing of the area 124 via the side mirror 118 is obstructed, the camera 136 captures image(s) and/or video of the area 124 and the display 130 presents the image(s) and/or video of the area 124 to the driver.

Further, the obstruction identifier 154 determines whether viewing of the area 126 behind the vehicle 100 is obstructed in response to the sensor module 148 detecting opaque material on the rearview mirror 120, the sensor module 150 detecting opaque material on the rearview window 106, and/or the sensor module 152 detecting an object within the cabin 102. The camera 136 captures image(s) and/or video of the area 126 and the display 130 presents the image(s) and/or video of the area 126 to the driver in response to the obstruction identifier 154 determining that viewing of the area 122 via the rearview mirror 120 is obstructed.

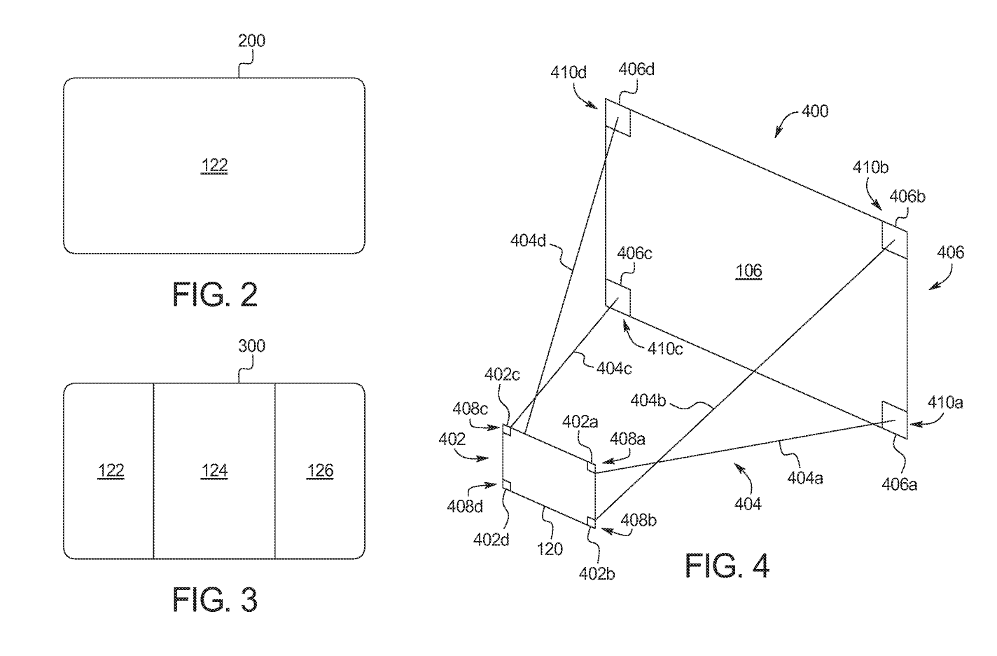

FIG. 2 depicts a screen 200 (e.g., a first screen) that presented via the display 130 of the vehicle 100. The screen 200 of the illustrated example is presented via the display 130 in response to the obstruction identifier 154 determining that the driver is unable to view the area 122, the area 124, or the area 126 adjacent to the vehicle due to opaque material on a vehicle surface and/or an object located within the cabin 102 of the vehicle 100. That is, the display 130 presents image(s) and/or video of one of the area 122, the area 124, or the area 126 when that respective one of the area 122, the area 124, or the area 126 is obstructed. For example, the screen 200 includes image(s) and/or video of the area 122 captured by the camera 134, the area 124 capture by the camera 136, or the area 126 capture by the camera 138.

FIG. 3 depicts another screen 300 (e.g., a second screen) that is presented via the display 130 of the vehicle 100. The screen 300 is presented via the display 130 in response to the obstruction identifier 154 determining that the driver is unable to view the area 122, the area 124, and the area 126 due to opaque material on a vehicle surface and/or an object within the cabin 102. That is, the display 130 presents a split-screen of image(s) and/or video of the area 122, the area 124, and the area 126 when the obstruction identifier 154 determines that each of the area 122, the area 124, and the area 126 is obstructed. In other examples, the display 130 presents a split-screen of image(s) and/or video of two of the area 122, the area 124, and the area 126 when the obstruction identifier 154 determines that two of the area 122, the area 124, and the area 126 are obstructed.

FIG. 4 illustrates an example sensor module 400 (e.g., the sensor module 152 of FIG. 1) that is utilized to detect an object within the cabin 102 of the vehicle 100 that obstructs a view of the area 126 via the rearview mirror 120. As illustrated in FIG. 4, the sensor module 400 includes light transmitters 402 (e.g., LED transmitters, infrared transmitters, laser transmitters) that emit light beams 404 toward sensors 406 (e.g., LED receivers, infrared receivers, laser receivers).

The light transmitters 402 of the illustrated example are coupled to the rearview mirror 120 of the vehicle 100. In other examples, the light transmitters 402 may be coupled to any surface near the rearview mirror 120 within the cabin 102 that facilitates detection of objects within the cabin 102 that obstruct the driver from viewing the area 126 via the rearview mirror 120. Additionally, the sensors 406 are coupled to and/or are otherwise positioned adjacent to the rearview window 106 of the vehicle 100.

The sensors 406 collect light intensity measurements of the light beams 404. When one or more of the sensors 406 collects a light intensity measurement that is less than a reference light intensity associated with an unobstructed view, the sensor module 400 detects that an object located within the cabin 102 obstructs the driver's view of the area 126 via the rearview mirror 120. In some examples, the light transmitters 402 and/or the sensors 406 are positioned and/or oriented such that objects that do not block a view of the driver (e.g., the driver, vehicle seats, seat headrests) do not affect (e.g., reduce) the light intensity measurements collected by the sensors 406.

In the illustrated example, the light transmitters 402 emit the light beams 404 in a crisscross pattern toward the respective sensors 406 to increase an area within the cabin 102 in which an object may be detected by the sensor module 400.

For example, the light transmitters 402 include a light transmitter 402a (e.g., a first of the light transmitters) that emits a light beam 404a (e.g., a first light beam) toward the rearview window 106, a light transmitter 402b (e.g., a second of the light transmitters) that emits a light beam 404b (e.g., a second light beam) toward the rearview window 106, a light transmitter 402c (e.g., a third of the light transmitters) that emits a light beam 404c (e.g., a third light beam) toward the rearview window 106, and a light transmitter 402d (e.g., a fourth of the light transmitters) that emits a light beam 404d (e.g., a fourth light beam) toward the rearview window 106. Further, the sensors 406 include a sensor 406a (e.g., a first of the sensors) that is to receive the light beam 404a, a sensor 406b (e.g., a second of the sensors) that is to receive the light beam 404b, a sensor 406c (e.g., a third of the sensors) that is to receive the light beam 404c, and a sensor 406d (e.g., a fourth of the sensors) that is to receive the light beam 404d.

In the illustrated example, the light transmitter 402a is coupled to an upper driver-side corner 408a of the rearview mirror 120 and emits the light beam 404a toward the light sensor 406A coupled to a lower driver-side corner 410a of the rearview window 106. Further, the light transmitter 402b is coupled to a lower driver-side corner 408b of the rearview mirror 120 and emits the light beam 404b toward the sensor 406b coupled to an upper driver-side corner 410b of the rearview window 106 such that the light beam 404a and the light beam 404b crisscross within the cabin 102 of the vehicle 100. Additionally, the light transmitter 402c is coupled to an upper passenger-side corner 408c of the rearview mirror 120 and emits the light beam 404c toward the sensor 406c coupled to a lower passenger-side corner 410c of the rearview window 106. The light transmitter 402d is coupled to a lower passenger-side corner 408d of the rearview mirror 120 and emits the light beam 404d toward the sensor 406d coupled to an upper passenger-side corner 410d of the rearview window 106 such that the light beam 404c and the light beam 404d crisscross within the cabin 102 of the vehicle 100.

FIG. 5 illustrates another example sensor module 500 (e.g., the sensor module 152 of FIG. 1) that is utilized to detect an object within the cabin 102 of the vehicle 100 that obstructs a view of the area 126 via the rearview mirror 120. As illustrated in FIG. 5, the sensor module 500 includes a light transmitter 502 (e.g., an LED transmitter, an infrared transmitter, a laser transmitter) that emits a light beam 504 toward sensors 506 (e.g., LED receivers, infrared receivers, laser receivers).

The light transmitter 502 of the illustrated example is coupled to the rearview mirror 120 of the vehicle 100. In other examples, the light transmitter 502 may be coupled to any surface near the rearview mirror 120 within the cabin 102 that facilitates detection of objects within the cabin 102 that obstruct the driver from viewing the area 126 via the rearview mirror 120. Further, the sensors 506 are coupled to and/or are otherwise positioned adjacent to the rearview window 106 of the vehicle 100. In the illustrated example, the sensors 506 form a matrix of sensors that include a plurality of sensors arrays. In other examples, the sensors are positioned along an outer edge 508 of the rearview window 106.

The sensors 506 collect light intensity measurements of the light beam 504. When one or more of the sensors 506 collects a light intensity measurement that is less than a reference light intensity associated with an unobstructed view, the sensor module 500 detects that an object located within the cabin 102 obstructs the driver's view of the area 126 via the rearview mirror 120. In some examples, the light transmitter 502 and/or the sensors 506 are positioned and/or oriented such that objects that do not block a view of the driver (e.g., the driver, vehicle seats, seat headrests) do not affect (e.g., reduce) the light intensity measurements collected by the sensors 506.

As illustrated in FIG. 5, the light beam 504 emitted by the light transmitter 502 toward the rearview window 106 is an unfocused light beam. In the illustrated example, the light transmitter 502 is a laser transmitter and the light beam 504 that is unfocused is a Gaussian beam. In other examples, the light transmitter 502 is an LED transmitter and the light beam 504 that is unfocused is a scatter beam.

FIG. 6 depicts a partial cross-sectional view of the rearview window 106 and the sensors 506 of the sensor module 500. In the illustrated example, the sensors 506 are coupled to an exterior surface 602 of the rearview window 106. Because of the position of the sensors 506 relative to the rearview window 106, light intensity measurements collected by the sensors 506 are affected by (e.g., reduced as a result of) opaque material that is located on an interior surface 604 of the rearview window 106. As a result, the sensors 506 coupled to the exterior surface 602 of the rearview window 106 enable the sensor module 500 to detect opaque material on the rearview window 106 that obstructs the driver's view of the area 126 via the rearview mirror 120.

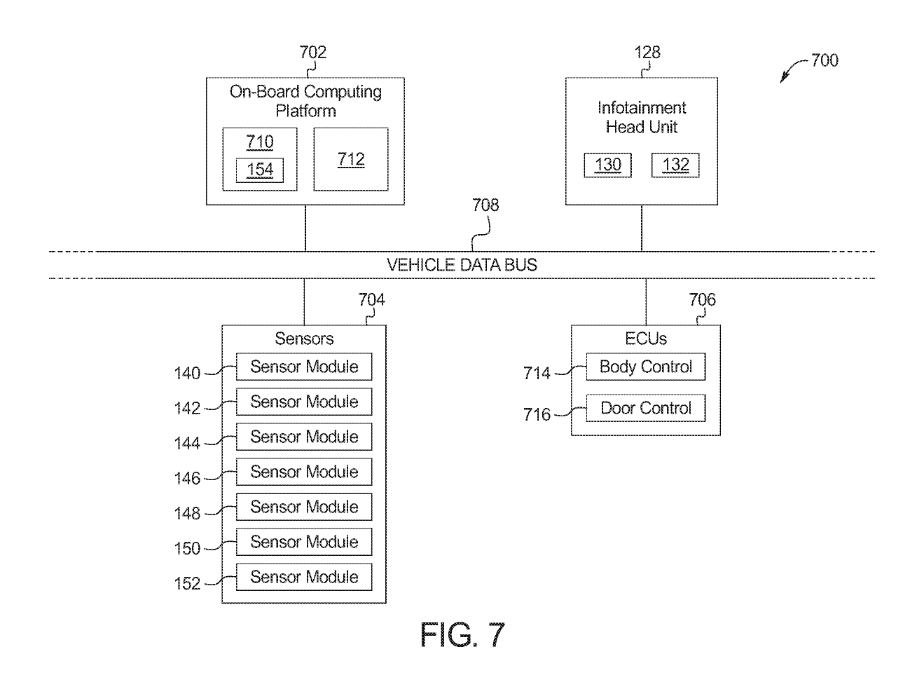

FIG. 7 is a block diagram of electronic components 700 of the vehicle 100. In the illustrated example, the electronic components include an on-board computing platform 702, the infotainment head unit 128, sensors 704, electronic control units (ECUs) 706, and a vehicle data bus 708.

The on-board computing platform 702 includes a microcontroller unit, controller or processor 710 and memory 712. In some examples, the processor 710 of the on-board computing platform 702 is structured to include the obstruction identifier 154. Alternatively, in some examples, the obstruction identifier 154 is incorporated into another electronic control unit (ECU) with its own processor 710 and memory 712. The processor 710 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 712 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 712 includes multiple kinds of memory, particularly volatile memory and non-volatile memory.

The memory 712 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 712, the computer readable medium, and/or within the processor 710 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 704 are arranged in and around the vehicle 100 to monitor properties of the vehicle 100 and/or an environment in which the vehicle 100 is located. One or more of the sensors 704 may be mounted to measure properties around an exterior of the vehicle 100. Additionally or alternatively, one or more of the sensors 704 may be mounted inside a cabin of the vehicle 100 or in a body of the vehicle 100 (e.g., an engine compartment, wheel wells, etc.) to measure properties in an interior of the vehicle 100. For example, the sensors 704 include accelerometers, odometers, tachometers, pitch and yaw sensors, wheel speed sensors, microphones, tire pressure sensors, biometric sensors and/or sensors of any other suitable type. In the illustrated example, the sensors 704 include the sensor module 140 and the sensor module 142 to detect whether viewing the area 122 via the side mirror 116 is obstructed; the sensor module 144 and the sensor module 146 to detect whether viewing the area 124 via the side mirror 118 is obstructed; and the sensor module 148, the sensor module 150, and the sensor module 152 (e.g., the sensor module 400, the sensor module 500) to detect whether viewing the area 126 via the rearview mirror 120 is obstructed.

The ECUs 706 monitor and control the subsystems of the vehicle 100. For example, the ECUs 706 are discrete sets of electronics that include their own circuit(s) (e.g., integrated circuits, microprocessors, memory, storage, etc.) and firmware, sensors, actuators, and/or mounting hardware. The ECUs 706 communicate and exchange information via a vehicle data bus (e.g., the vehicle data bus 708). Additionally, the ECUs 706 may communicate properties (e.g., status of the ECUs 706, sensor readings, control state, error and diagnostic codes, etc.) to and/or receive requests from each other. For example, the vehicle 100 may have seventy or more of the ECUs 706 that are positioned in various locations around the vehicle 100 and are communicatively coupled by the vehicle data bus 708.

In the illustrated example, the ECUs 706 include a body control module 714 and a door control unit 716. For example, the body control module 714 controls one or more subsystems throughout the vehicle 100, such as an immobilizer system, an HVAC system, etc. For example, the body control module 714 includes circuits that drive one or more of relays (e.g., to control wiper fluid, etc.), brushed direct current (DC) motors (e.g., to control wipers, etc.), stepper motors, LEDs, etc. The door control unit 716 controls one or more electrical systems located on doors of the vehicle 100, such as power windows, power locks, power mirrors, mirror heating elements, etc. For example, the door control unit 716 includes circuits that drive one or more of relays brushed direct current (DC) motors (e.g., to control power seats, power locks, power windows, etc.), stepper motors, LEDs, etc.

The vehicle data bus 708 communicatively couples the infotainment head unit 128, the on-board computing platform 702, the sensors 704, and the ECUs 706. In some examples, the vehicle data bus 708 includes one or more data buses. The vehicle data bus 708 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

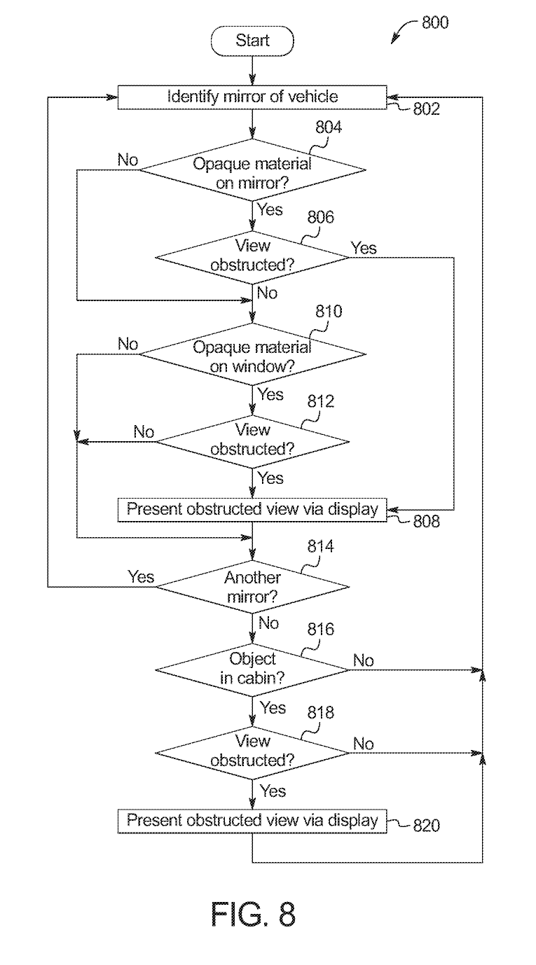

FIG. 8 is a flowchart of an example method 800 to detect and present obstructed views of a vehicle. The flowchart of FIG. 8 is representative of machine readable instructions that are stored in memory (such as the memory 712 of FIG. 7) and include one or more programs which, when executed by a processor (such as the processor 710 of FIG. 7), cause the vehicle 100 to implement the example the example obstruction identifier 154 of FIGS. 1 and 7. While the example program is described with reference to the flowchart illustrated in FIG. 8, many other methods of implementing the example obstruction identifier 154 may alternatively be used. For example, the order of execution of the blocks may be rearranged, changed, eliminated, and/or combined to perform the method 800. Further, because the method 800 is disclosed in connection with the components of FIGS. 1-7, some functions of those components will not be described in detail below.

Initially, at block 802, the obstruction identifier 154 identifies a mirror of the vehicle 100. For example, the obstruction identifier 154 identifies the side mirror 116 (e.g., a first side mirror). At block 804, a sensor module detects whether opaque material (e.g., condensation, rain droplets, ice, snow, a cracked surface) is located on the mirror. For example, the sensor module 140 (e.g., a first sensor module) detects whether opaque material is on the side mirror 116.

In response to the sensor module detecting that opaque material is on the mirror, the method 800 proceeds to block 806 at which the obstruction identifier 154 determines whether the opaque material obstructs a driver from viewing an area adjacent to the vehicle 100 via the mirror. For example, the obstruction identifier 154 determines whether the opaque material obstructs the driver from viewing the area 122 (e.g., a first area) via the side mirror 116. In response to the obstruction identifier 154 determining that the opaque material obstructs the driver from viewing the area adjacent to the vehicle 100, the method 800 proceeds to block 808. At block 808, a camera collects image(s) and/or video of the area and the display 130 of the vehicle 100 presents the obstructed view to the driver. For example, the camera 134 (e.g., a first camera) collects image(s) and/or video of the area 122 and the display 130 presents the image(s) and/or video of the area 122 to the driver.

Otherwise, in response to the sensor module not detecting opaque material at block 804 or upon the obstruction identifier 154 determining at block 806 that the opaque material does not obstruct the view of the driver, the method 800 proceeds to block 810. At block 810, another sensor module detects whether opaque material is on a window that corresponds to the identified mirror. For example, the sensor module 142 (e.g., a second sensor module) detects whether opaque material is on the side window 108 (e.g., a first side window). In response to the sensor module detecting that opaque material is on the window, the method 800 proceeds to block 812 at which the obstruction identifier 154 determines whether the opaque material obstructs a driver from viewing the area adjacent to the vehicle 100 via the identified mirror. For example, the obstruction identifier 154 determines whether the opaque material obstructs the driver from viewing the area 122 via the side mirror 116. In response to the obstruction identifier 154 determining that the opaque material obstructs the driver from viewing the area adjacent to the vehicle 100, the method 800 proceeds to block 808 at which the display 130 presents the obstructed view to the driver. For example, the camera 134 collects or captures image(s) and/or video of the area 122 and the display 130 presents the image(s) and/or video of the area 122 to the driver.

The method proceeds to block 814 in response to the display 130 presenting the image(s) and/or video of the obstructed area at block 808, in response to the sensor module not detecting opaque material at block 810, or in response to the obstruction identifier 154 determining that the opaque material does not obstruct the view of the driver at block 812. At block 814, the obstruction identifier 154 determines whether there is another mirror of the vehicle 100 to monitor. In response to determining that there is another mirror (e.g., the side mirror 118, the rearview mirror 120), the method 800 returns to block 802 to repeat blocks 802, 804, 806, 808, 810, 812.

For example, the sensor module 144 (e.g., a third sensor module) detects whether opaque material is on the side mirror 118 (e.g., a second side mirror) (block 804). In response to the sensor module 144 detecting opaque material on the side mirror 118, the obstruction identifier 154 determines whether a view of the area 124 (e.g., a second area) by the driver is obstructed by the opaque material (block 806). Further, the sensor module 146 (e.g., a fourth sensor module) detects whether opaque material is on the side window 110 (e.g., a second side window) (block 810). In response the sensor module 146 detecting opaque material on the side window 110, the obstruction identifier 154 determines whether a view of the area 124 by the driver is obstructed by the opaque material (block 812). In response to the obstruction identifier 154 determining that viewing of the area 124 via the side mirror 118 is obstructed, the camera 136 captures and the display 130 presents image(s) and/or video of the area 122 to the driver (block 808).

Additionally or alternatively, the sensor module 148 (e.g., a fifth sensor) detects whether opaque material is on the rearview mirror 120 (block 804). In response to the sensor module 148 detecting opaque material on the rearview mirror 120, the obstruction identifier 154 determines whether a view of the area 126 (e.g., a third area) by the driver is obstructed by the opaque material (block 806). Further, the sensor module 150 (e.g., a sixth mirror) and/or the sensor module 152 (e.g., a seventh mirror) detects whether opaque material is on the rearview window 106 (block 810). In response to the sensor module 150 and/or the sensor module 152 detecting opaque material on the rearview mirror 120, the obstruction identifier 154 determines whether a view of the area 126 by the driver is obstructed by the opaque material (block 812). In response to the obstruction identifier 154 determining that viewing of the area 126 via the rearview mirror 120 is obstructed, the camera 138 captures and the display 130 presents image(s) and/or video of the area 122 to the driver (block 808).

In response to determining at block 814 that there is not another mirror to monitor, the method 800 proceeds to block 816 at which the sensor module 152 detects whether there is an object in the cabin 102 of the vehicle 100 that is between the driver's view of the area 126 via the rearview mirror 120. In response to the sensor module 152 detecting that the there is not an object in the cabin 102, the method 800 returns to block 802. In response to the sensor module 152 detecting that the there is an object in the cabin 102, the method 800 proceeds to block 818 at which the obstruction identifier 154 determines whether the object obstructs a driver from viewing the area 126 via the rearview mirror 120. In response to the obstruction identifier 154 determining that the driver's view of the area 126 via the rearview mirror 120 is not obstructed, the method 800 returns to block 802. Otherwise, in response to the obstruction identifier 154 determining that the driver's view of the area 126 via the rearview mirror 120 is obstructed by the object, the method 800 proceeds to block 820 at which the camera 138 captures and the display 130 presents image(s) and/or video of the area 122 to the driver.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a first side mirror;
a first camera adjacent to the first side minor;
a first sensor module to detect opaque material on the first side mirror;
an obstruction identifier to determine whether viewing of a first area via the first side mirror is obstructed; and
a display to present, via the first camera, the first area responsive to the obstruction identifier determining viewing via the first side minor is obstructed.

2. The vehicle of claim 1, further including a first side window adjacent to the first side minor and a second sensor module to detect opaque material on the first side window.

3. The vehicle of claim 1, further including:
a second side mirror for viewing a second area;
a second camera adjacent to the second side mirror; and
a third sensor module to detect opaque material on the second side mirror, wherein the obstruction identifier determines whether viewing of the second area via the second side mirror is obstructed and the display presents, via the second camera, the second area responsive to the obstruction identifier determining that viewing via the second side mirror is obstructed.

4. The vehicle of claim 3, further including a second side window adjacent to the second side mirror and a fourth sensor module to detect opaque material on the second side window.

5. The vehicle of claim 1, further including:
a rearview window;
a rearview mirror for viewing a third area;
a third camera adjacent to the rearview window; and
a fifth sensor module to detect opaque material on the rearview mirror, wherein the obstruction identifier determines whether viewing of the third area via the rearview mirror is obstructed and the display presents, via the third camera, the third area responsive to the obstruction identifier determining that viewing via the rearview mirror is obstructed.

6. The vehicle of claim 5, further including a sixth sensor module for detecting whether opaque material is on the rearview window that obstructs viewing of the third area.

7. The vehicle of claim 5, further including a seventh sensor module for detecting whether an object is positioned between the rearview mirror and the rearview window that obstructs viewing of the third area via the rearview mirror.

8. The vehicle of claim 7, wherein the seventh sensor module includes:
a light transmitter that is coupled to the rearview mirror and emits an unfocused light beam toward the rearview window; and
sensors that are coupled to the rearview window and collect light beam intensity measurements of the unfocused light beam.

9. The vehicle of claim 8, wherein the sensors are coupled to an exterior surface of the rearview window to enable the seventh sensor module to detect whether opaque material is on an interior surface of the rearview window.

10. The vehicle of claim 7, wherein the seventh sensor module includes:
light transmitters that are coupled to the rearview mirror and emit light beams toward the rearview window; and
sensors that are coupled to the rearview window and collect light beam intensity measurements of the light beams emitted by the light transmitters.

11. The vehicle of claim 10, wherein:
a first of the light transmitters is coupled to an upper driver-side corner of the rearview mirror and emits a first light beam toward a first of the sensors coupled to a lower driver-side corner of the rearview window;
a second of the light transmitters is coupled to a lower driver-side corner of the rearview mirror and emits a second light beam toward a second of the sensors coupled to an upper driver-side corner of the rearview window;
a third of the light transmitters is coupled to an upper passenger-side corner of the rearview mirror and emits a third light beam toward a third of the sensors coupled to a lower passenger-side corner of the rearview window; and
a fourth of the light transmitters is coupled to a lower passenger-side corner of the rearview mirror and emits a fourth light beam toward a fourth of the sensors coupled to an upper passenger-side corner of the rearview window.

12. The vehicle of claim 1, wherein the display presents a split-screen to present the first area and a second area responsive to the obstruction identifier determining that viewing of the first area and the second area is obstructed.

13. The vehicle of claim 1, wherein the opaque material is at least one of condensation, rain droplets, ice, snow, and a cracked surface.

14. A method for detection and presentation of obstructed vehicle views, the method comprising:
detecting, via a first sensor module, opaque material on a first side mirror;
determining, via a processor, whether viewing of a first area via the first side mirror is obstructed; and
capturing the first area via a camera and presenting the first area via a display responsive to determining that viewing of the first area is obstructed.

15. The method of claim 14, further including detecting, via a second sensor module, opaque material on a first side window adjacent to the first side mirror.

16. The method of claim 14, further including presenting, via the display, a second area captured via a second camera responsive to determining that viewing of the second area via a second side mirror is obstructed.

17. The method of claim 16, further including:
detecting, via a third sensor module, opaque material on the second side mirror;
detecting, via a fourth sensor module, opaque material on a second side window adjacent to the second side mirror; and
determining whether viewing via the second side mirror is obstructed.

18. The method of claim 14, further including presenting, via the display, a third area captured via a third camera responsive to determining that viewing of the third area via a rearview mirror is obstructed.

19. The method of claim 18, further including:
detecting, via a fifth sensor module, opaque material on the rearview mirror;
detecting, via a sixth sensor module, opaque material on a rearview window;
detecting, via a seventh sensor module, an object positioned between the rearview mirror and the rearview window; and
determining whether viewing via the rearview mirror is obstructed.

20. A vehicle comprising:
a rearview mirror;
a camera adjacent to a rearview window;
a sensor module to detect opaque material on the rearview mirror;
an obstruction identifier to determine whether viewing of an area via the rearview mirror is obstructed; and
a display to present, via the camera, the area responsive to the obstruction identifier determining that viewing via the rearview mirror is obstructed.
